(19) United States
(12) Patent Application Publication
(10) Pub. No.: US 2011/0084119 A1
(43) Pub. Date: Apr. 14, 2011

(54) Pocket and folder with pocket

(76) Inventor: Shannon Zapalac, Smithville, TX (US)

(21) Appl. No.: 12/924,911

(22) Filed: Oct. 7, 2010

Related U.S. Application Data
(60) Provisional application No. 61/278,831, filed on Oct. 13, 2009.

(51) Int. Cl. B65D 27/00; B31B 1/62; B31B 19/60

(52) U.S. Cl. 229/67.1; 493/264; 493/210

(57) ABSTRACT

The present invention discloses, in certain aspects, a pocket for a folder; a folder with at least one pocket; and methods for making a folder, the methods including, in one aspect, positioning a pocket adjacent a folder, folding a side portion of the pocket over a side edge of the folder, folding a bottom portion of the pocket over a bottom edge of the folder, connecting the side portion of the pocket to the folder, and connecting the bottom portion of the pocket to the folder, in one aspect, using adhesive strips on the pocket to connect the pocket to the folder. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### RELATED APPLICATION

The present invention and application claim priority under the United States Patent Laws from U.S. application Ser. No. 61/278,831 filed 10/13/2009, said application incorporated fully herein for all purposes.

### BACKGROUND OF THE INVENTION

1. Field Of The Invention

The present invention is directed to a pocket for a folder, a folder with one or more such pockets, and to methods for making a folder with at least one pocket.

2. Description of Related Art

There is a wide variety of known pockets for folders, folders with pocket(s), and methods for making a folder with pocket(s), including, but not limited to and only by way of example, those disclosed in U.S. Pat. Nos. 7,165,713 filed Jan. 23, 2007; No. 7,153,254 filed Dec. 26, 2006; No. 6,695,519 filed Feb. 24, 2004; No. 6,776,437 filed Aug. 17, 2004; No. 6,382,864 filed May 7, 2002; No. 6,241,285 filed Jun. 5, 2001; No. 6,082,612 filed Jul. 4, 2000; No. 5,873,513 filed Feb. 23, 1999; No. 5,598,969 filed Feb. 4, 1997; No. 5,375,705 filed Dec. 27, 1994; No. 5,275,438 filed Jan. 4, 1994; No. 5,174,606 filed Dec. 29, 1992; No. 4,989,777 filed Feb. 5, 1991; No. 4,771,557 filed Sep. 20, 1988; No. 4,703,952 filed Nov. 3, 1987; No. 3,553,864 filed Jan. 22, 1968; No. 2,568,941 filed Apr. 15, 1949; and U.S. Design Patents Nos. D577,768 filed Sep. 30, 2008; D567,286 filed Apr. 22, 2008; D523,474 filed Jun. 20, 2006; D432,166 filed Oct. 17, 2000; D400,578 filed Nov. 3, 1998; D351,619 filed Oct. 18, 1994; D308,887 filed Jun. 26, 1990; D306,314 filed Feb. 27, 1990; and D267,152 filed Dec. 7, 1982 (all said patents incorporated fully herein for all purposes).

There has long been a need, recognized by the present inventor, for an efficient and effective pocket for a folder, a folder with such a pocket, and for quick and easy methods for making such a folder.

### SUMMARY OF THE PRESENT INVENTION

The present invention, in certain aspects, discloses a pocket for a folder, the pocket having a sheet body with a main body, a side portion and a bottom portion. The side portion is foldable to fold around a side part of a folder and the bottom portion is foldable to fold around a bottom part of a folder. The side and bottom portions can be connected to, glued to, or otherwise adhered to the folder; or the side portion and the bottom portion can be provided with an amount of adhesive for adhesively attaching the portions to the folder.

In one aspect, the side portion of such a pocket has an adhesive strip initially covered with a removable cover piece and the bottom portion has an adhesive strip initially covered with a removable cover piece. Upon removal of the cover pieces, the adhesive strips are exposed so that the side portion is adhesively connectible to the side of the folder and the bottom portion is adhesively connectible to the bottom of the folder.

In certain aspects, a scored line or “line of weakness” is provided for facilitating the folding of the side portion and a scored line is provided for facilitating the folding of the bottom portion. Optionally, a slit or slits are provided in the pocket for holding an item to the pocket.

In certain aspects, the present invention discloses a folder that maybe used as a document folder, a presentation folder, or a portfolio. The folder has one, two, or more pockets connected thereto according to the present invention. In one aspect, a kit is provided that includes a folder and at least one pocket for attachment to the folder.

In certain aspects, the present invention discloses a method for making a folder that includes placing a pocket according to the present invention adjacent a part of a folder and then folding a side portion of the pocket over a side edge of the folder. A bottom portion of the pocket is folded over a bottom edge of the folder. The side portion and the bottom portion are connected to (e.g. stapled, taped, etc.), glued to, or otherwise adhered to the folder. In one aspect, the side portion has an adhesive strip initially covered with a removable cover piece and the bottom portion has an adhesive strip covered with a removable cover piece. The covers are removed and the side and bottom portions, after they have been folded over edges of the folder, are pressed against the folder thereby adhesively connecting these portions to the folder to hold the pocket in place on the folder. In one aspect, multiple pockets are connected to the folder.

Accordingly, the present invention includes features and advantages which are believed to enable it to advance folder pocket technology. Characteristics and advantages of the present invention described above and additional features and benefits will be readily apparent to those skilled in the art upon consideration of the following description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions of embodiments preferred at the time of filing for this patent that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain embodiments of the invention, other objects and purposes will be readily apparent to one of skill in this art who has the benefit of this invention's teachings and disclosures. It is, therefore, an object of at least certain embodiments of the present invention to provide the embodiments and aspects listed above and:

New, useful, unique, efficient, nonobvious pockets for folders and folders with such a pocket or pockets;

New, useful, unique, efficient, nonobvious methods for making a folder with one, at least one, or a plurality of pockets; and

Such methods that include the connection to a folder of a pocket with a main body that is one unfolded sheet of material.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly, from a cursory inspection or review. the nature and general area of the disclosure of this invention. The Abstract is neither intended to define the invention, which is done by the claims, nor is it intended to be limiting of the scope of the invention or of the claims in any way.

It will be understood that the various embodiments of the present invention may include one or some, in any possible combination, of the disclosed, described, and/or enumerated improvements, aspects and/or technical advantages and/or elements in claims to this invention may be used in any embodiment hereof.

Certain aspects, certain embodiments, and certain preferable features of the invention are set out herein. Any combination of aspects or features shown in any aspect or embodiment can be used in any other embodiment except where such aspects or features are mutually exclusive.

### BRIEF DESCRIPTION OF THE SEVERAL VIEWS OF THE DRAWINGS

A description of embodiments briefly summarized above may be had by reference to the drawings which form a part of this specification. These drawings illustrate embodiments preferred at the time of filing for this patent and are not to be used to improperly limit the scope of the invention which may have other equally effective or legally equivalent embodiments.

FIG. 1 is a front view of a pocket according to the present invention.

FIG. 2 is a rear view of the pocket of FIG. 1.

FIG. 3 is an end view of the pocket of FIG. 1.

FIG. 4 is an end view of the pocket of FIG. 1.

FIG. 5 is a top view of the pocket of FIG. 1.

FIG. 6 is a bottom view of the pocket of FIG. 1.

FIG. 7 is an inner view of a folder and a front view of two pockets according to the present invention.

FIG. 8 is an inner view of the folder of FIG. 7 with the pockets of FIG. 7 positioned adjacent the folder.

FIG. 9 shows the pockets of FIG. 8 with portions folded over edges of the folder of FIG. 7.

FIG. 10 is a front view of a folder according to the present invention with the pockets of FIG. 7.

FIG. 11 is a perspective view of the folder of FIG. 10.

FIG. 12 is a rear view of a pocket according to the present invention.

FIG. 13 is a front view of a pocket according to the present invention.

FIG. 14 is a front view of a pocket according to the present invention.

FIG. 15 is a rear view of a pocket according to the present invention.

FIG. 16 is a rear view of a pocket according to the present invention.

FIG. 17 is a rear view of a pocket according to the present invention.

FIG. 18 is an inner view of a folder and a front view of two pockets according to the present invention.

FIG. 19 is an inner view of a folder and a front view of two pockets according to the present invention.

FIG. 20 is a cross-section view (not to scale) of part of the folder of FIG. 19.

FIG. 21A is a front view of a pocket according to the present invention.

FIG. 21B is a front view of a pocket according to the present invention.

FIG. 22A is a front view of a pocket according to the present invention.

FIG. 22B is a front view of a pocket according to the present invention.

FIG. 22C is a perspective view of a pocket according to the present invention.

FIG. 22D is a perspective view of a pocket according to the present invention.

FIG. 23A is a front view of a pocket according to the present invention.

FIG. 23B is a front view of a pocket according to the present invention.

FIG. 24A is a front view of a pocket according to the present invention.

FIG. 24B is a perspective view of a pocket according to the present invention.

FIG. 24C is an inner view of a folder according to the present invention with a pocket according to the present invention.

FIG. 24D is an inner view of a folder according to the present invention with pockets according to the present invention.

Certain embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiments, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein. The drawing figures present the embodiments preferred at the time of filing for this patent.

### DETAILED DESCRIPTION OF THE INVENTION

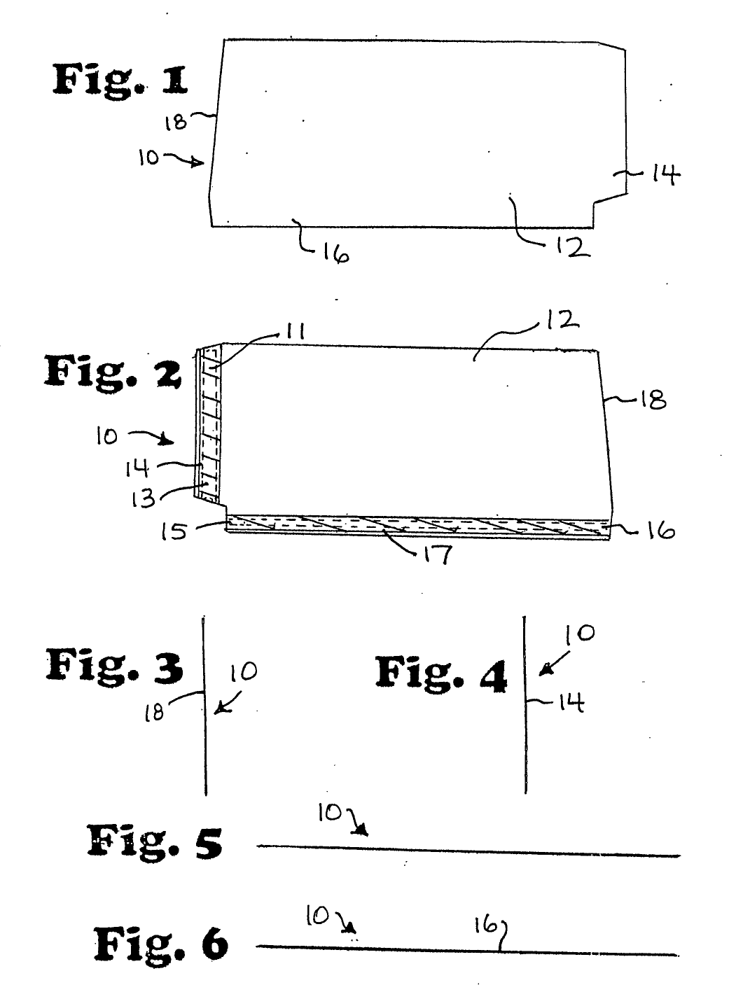

FIGS. 1-6 illustrate a pocket 10 according to the present invention which has a main body 12, a side portion 14 and a bottom portion 16. The body 12 has a tapered edge 18.

The side portion 14 has an adhesive strip 11 thereon covered by a removable cover piece 13. The bottom portion 16 has an adhesive strip 15 thereon covered by a removable cover piece 17.

The main body 12 is a single sheet or thickness of suitable material, e.g., paper, kraft paper, or cellophane.

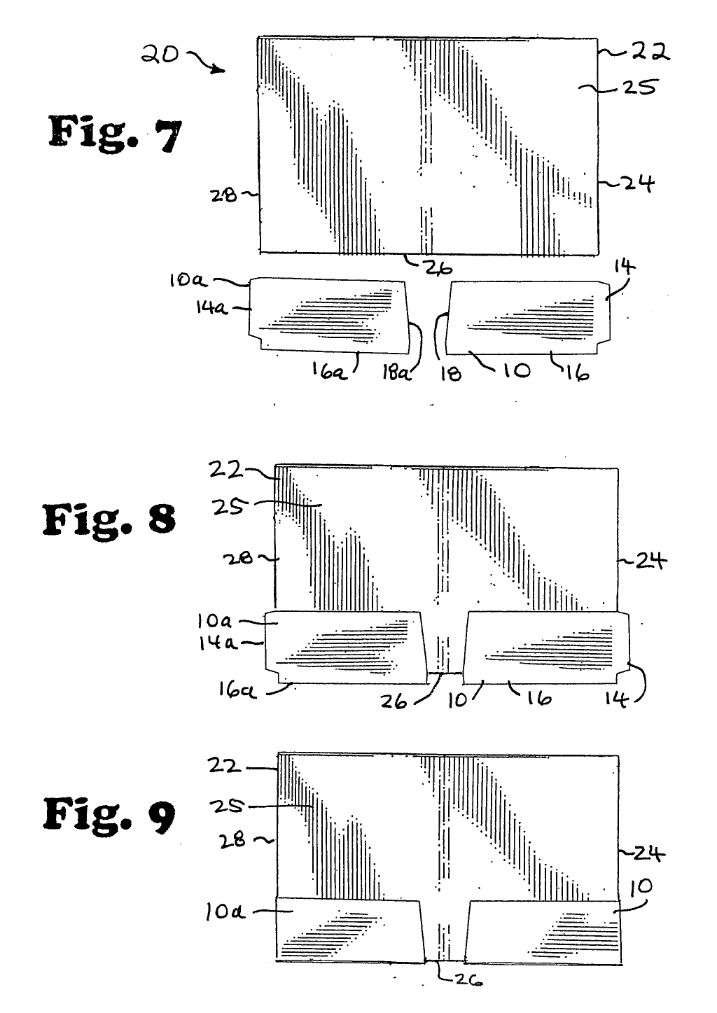

FIG. 1 shows a “right-handed” pocket 10. A “left-handed” pocket 10a (see FIG. 7) is a mirror image of the pocket 10. The numerals identifying parts of the pocket 10a are like the numerals 14, 16, 18 but with a suffix “a” added.

FIG. 7 shows a kit 20 according to the present invention which includes a folder body 22 with an exterior 27 and an interior 25, a pocket 10 according to the present invention, and a pocket 10a according to the present invention. As shown in FIG. 8, the pockets 10 and 10a have been positioned adjacent the interior 25 of the folder body 22 with: side portion 14 lined up with an edge 24 of the folder body 22; bottom portion 16 lined up with an edge 26 of the folder body 22; side portion 14a lined up with an edge 28 of the folder body 22; and bottom portion 16a lined up with the edge 26. Removable cover pieces 13, 13a, 17 and 17a have been removed from the pockets.

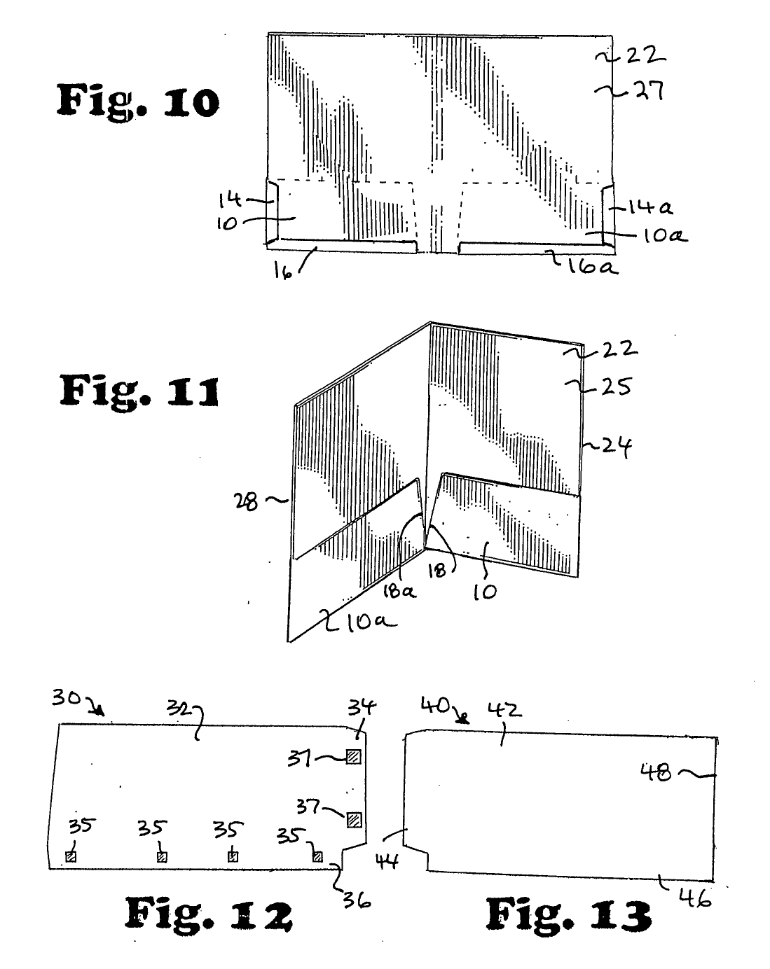

As shown in FIG. 9, the side portions 14, 14a and the bottom portions 16, 16a have been folded over the folder body edges. As shown in FIG. 10 side and bottom portions of the pockets have been pressed against parts of the folder body's exterior 27 to adhesively adhere these portions to the folder body.

FIG. 12 shows a pocket 30 according to the present invention which has a main body 32; a side portion 34 with amounts of adhesive 37; and a bottom portion 36 with amounts of adhesive 35. It is within the scope of the present invention to use one, three, four or more amounts of adhesive 35 and to use one, two-six, or more amounts of adhesive 37. The body 32 has an optional tapered edge 38.

FIG. 13 shows a pocket 40 according to the present invention which has a main body 42; a side portion 44; and a bottom portion 46. The body 42 has a non-tapered edge 48.

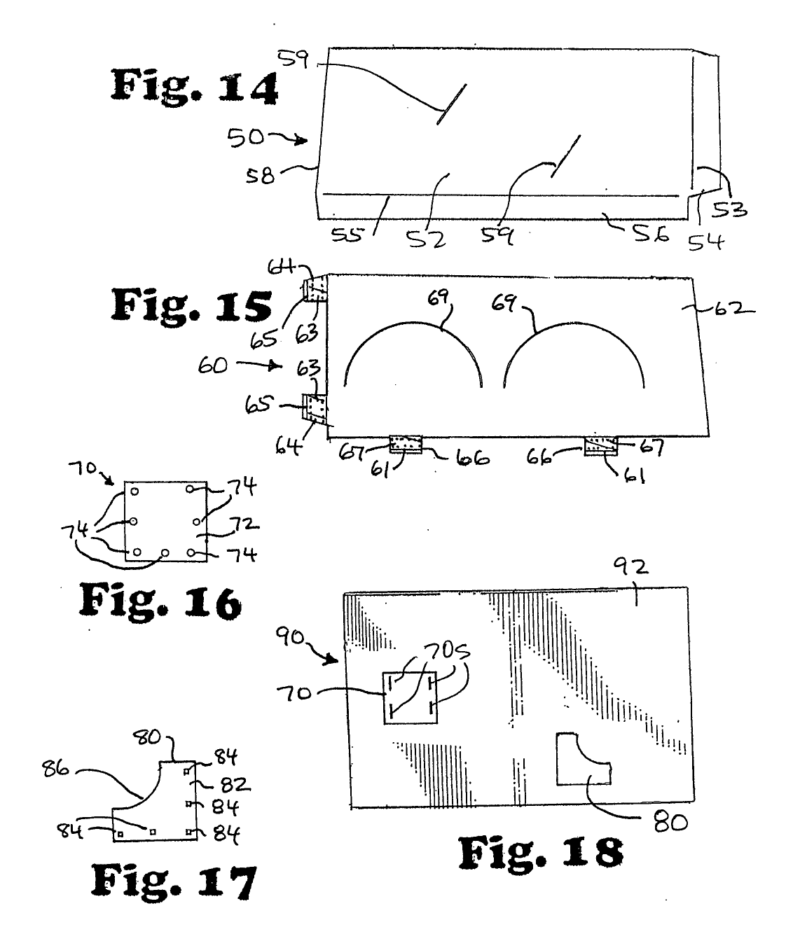

FIG. 14 shows a pocket 50 according to the present invention which has a main body 52; a side portion 54; a bottom portion 56; an optional tapered edge 58; and two slits 50. An item (not shown) can be used by the two slits 50 with part or parts of the item projecting into the slits. Either slit may be deleted and there may, according to the present invention, be three, four, five, six or more slits.

Optionally (and as is true for any side portion of any pocket according to the present invention) a scored line or “line of weakness” 53 is provided in the body 52 to facilitate folding of the side portion 54. Optionally (and as is true for any bottom portion of any pocket according to the present invention) a scored line or a “line of weakness” 55 is provided in the body 52 to facilitate folding of the bottom portion 56.

FIG. 15 illustrates a pocket 60 according to the present invention which has a body 62; side tabs 64; bottom tabs 66; an optional tapered edge 68; and optional slits 69. Each tab 64 has an amount of adhesive 63 thereon and a removable cover 65. Each tab 66 has an amount of adhesive 67 thereon and a removable cover 61.

It is within the scope of the present invention to delete either of the tabs 64 shown in FIG. 15 or to use three, four, five or more such tabs. It is within the scope of the present invention to delete either of the tabs 66 shown in FIG. 15 or to use three, four, five or more such tabs. Optionally, the adhesive 63, 67 is deleted and glue or a connector (e.g. stapes, tape, etc.) is used. As is true for any tab or side portion or bottom portion of any pocket according to the present invention, releasably cooperating fastener material, e.g., but not limited to, VELCRO (TM) fastener material may be used.

FIG. 16 shows a pocket 70 according to the present invention with a body 72 and amounts of adhesive 74 for connecting the pocket 70 to a folder body.

FIG. 17 shows a pocket 80 according to the present invention with a body 82 and amounts of adhesive 84 for connecting the pocket 80 to a folder body.

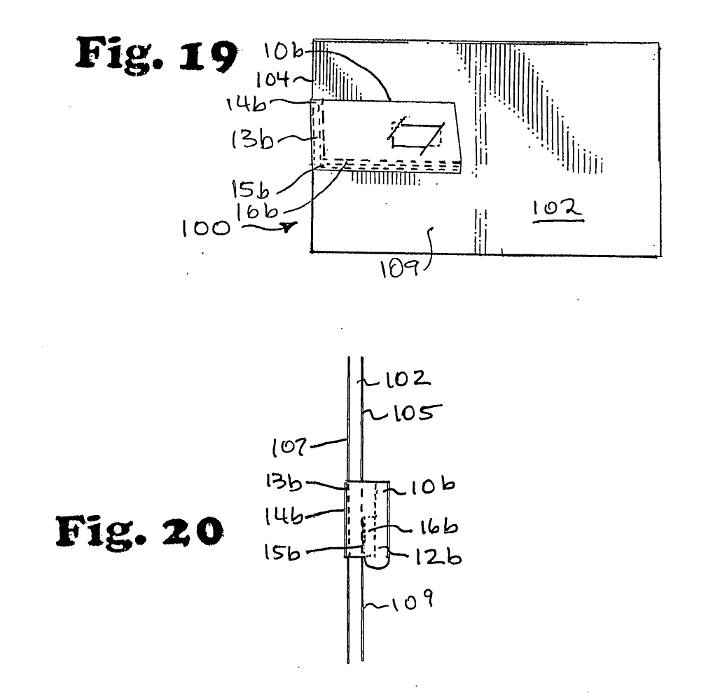

FIG. 18 shows a folder 90 according to the present invention with a folder body 92; a pocket 70 adhesively connected to the body 92; and a pocket 80 adhesively connected to the body 92. Optionally (or instead of adhesive) stapes 70s connect the pocket 70 to the folder 90 (as may be true for any pocket according to the present invention).

FIG. 19 shows a folder 100 according to the present invention with a pocket 10b according to the present invention. A bottom portion 16b of a pocket 10b has been folded with respect to the pocket 10b (not over an edge of the folder body 102). A side portion 14b has been folded over an edge 104 of the folder body 102 onto an exterior 107 of the folder body 102. The bottom portion 16b is between a pocket body 12b and an interior 109 of the folder body 102 with adhesive 15b adhering the bottom portion 16b to the interior of the folder body 102. Adhesive 13b on the side portion 14b adheres to the exterior of the folder body 102. These relationships are shown in FIG. 20 (not to scale). A business card BC is releasably held in slits.

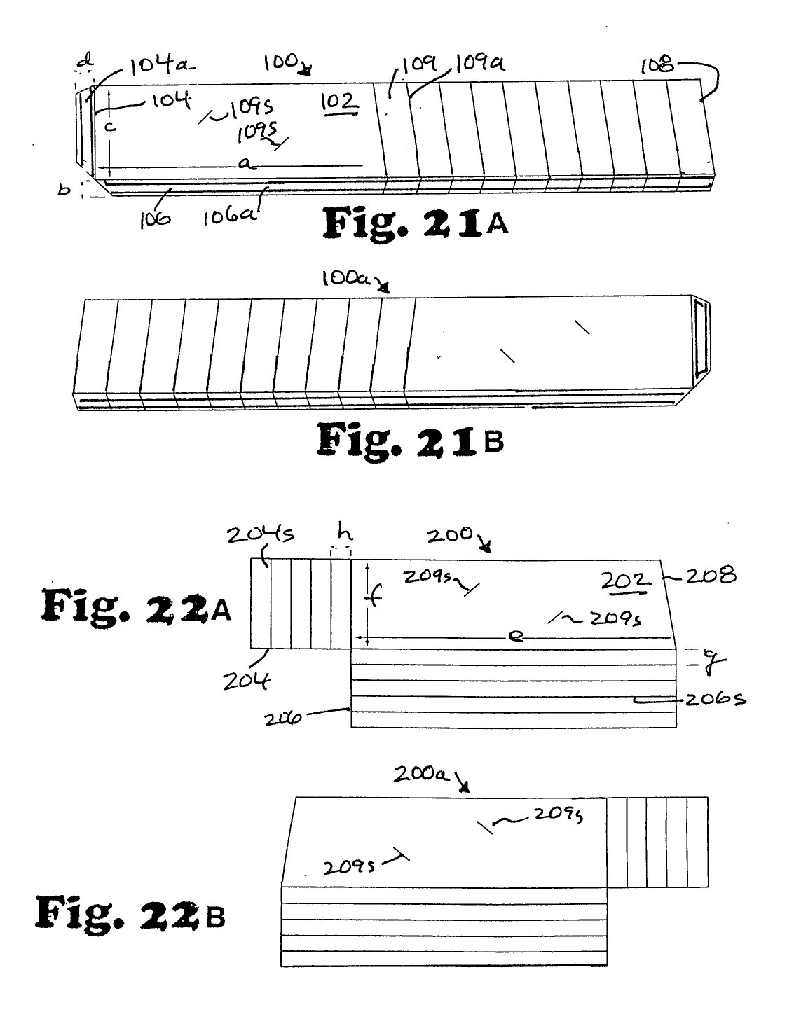

FIG. 21A shows a pocket 100 according to the present invention which has a main body 102, a side portion 104, an optional tapered edge 108, and a bottom portion 106. Adhesive strip 104a which has a removable cover is on the side portion 104. Adhesive strip 106a which has a removable cover is on bottom portion 106.

Optionally, the main body has a length “a”, or a length “a” plus an additional length corresponding to length “a” plus the length of one or more increments 109. For example, length “a” may be 5 inches and each increment 109 may be one inch. The main body is cut at a desired length. Optional lines 109a may be used to mark the increments 109. Optionally, the lines 109a are scored or perforated. Optional slits 109s can hold an item, e.g. a business card.

In one particular aspect, the length “a” is 5 inches; a measurement “b” is 0.5 inch; a measurement “c” 4 inches; and a measurement “d” is 0.5 inch.

FIG. 21B shows a pocket 100a which is a mirror image of the pocket 100.

The side portion 104 and the bottom portion 106 are folded and adhered to another thing (e.g. folder interior) as described above for similar pockets. In another aspect the adhesive strips 104a, 106a are in the reverse side of their respective portions and adhere to a reverse side of a thing (e.g. folder exterior).

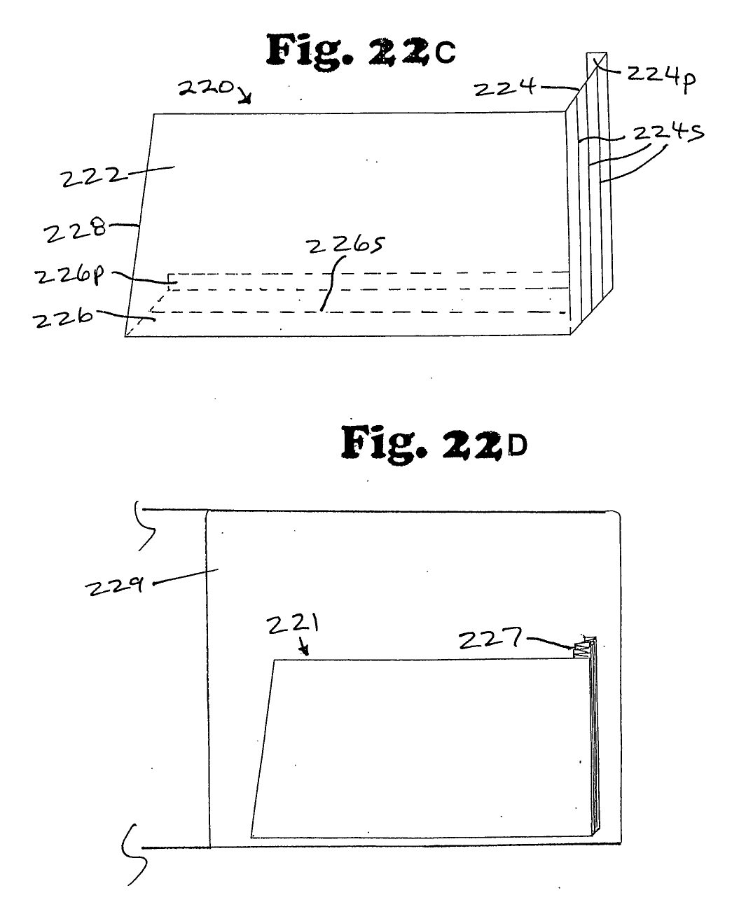

FIG. 22A shows a pocket 200 according to the present invention which has a main body 202, a side portion 204, a bottom portion 206, and an optional tapered edge 208. The side portion 204 has a covered adhesive strip 204a with removable cover and the bottom portion 206 has a covered adhesive strip 206a with a removable cover.

The side portion 204 has lines 204s which indicate locations for folds of the side portion 204. The bottom portion 206 has lines 206s which indicate locations for folds of the bottom portion 206. By folding one or both of these portions in accordion-fold fashion, an expandable pocket is provided which can expand to accommodate different amounts of contents, e.g. a different number of sheets of paper or cards.

In one aspect a length “e” is 5 inches; a width “f” is 4 inches; a measurement “g” is 0.5 inch; and a measurement “h” is 0.5 inch.

Any line 204s or 206s may be scored or perforated.

FIG. 22B shows a pocket 200a which is a mirror image of the pocket 200.

Optionally the pockets 200 and 200a have slits 209s.

FIG. 22C shows a pocket 220 according to the present invention which has a main body 222, a side portion 224, a bottom portion 226, and an optional tapered edge 228. Part 224p of the side portion 224 is folded for connection to a thing (e.g. to a folder's interior or exterior) and may be connected with any suitable adhesive strip (adhered to or separate from the pocket), glue, or tape. Part 226p of the bottom portion 226 is folded for connection to a part of a thing (e.g. a folder's interior or exterior).

Optionally, the side portion 224 could have been folded along any line 224s or the side portion could have been folded in accordion-like fashion. Optionally, the bottom portion 226 could have been folded along line 226s.

FIG. 22D shows a pocket 221 adhered to an inside part of a folder 229. A side portion 227 is folded in accordion fashion and its end is connected to the folder's interior. A bottom portion (not show; e.g. like bottom portions of pocket's described above) is also connected to the folder.

FIGS. 23A and 23B show pockets 230 and 231, respectively, according to the present invention which are like the pockets of FIGS. 22A, 22B, but without side portions like the side portion 204. The pocket 230 has a main body 232 and a bottom portion 236 which is foldable along any of lines 236s. An adhesive strip (not shown) may be provided on the bottom portion 236s.

In one aspect, the length “I” is 5 inches; the width “k” is 4 inches; and the measurement “m” is 3.75 inches.

The pocket 231 is a mirror image of the pocket 230. Optionally, the pockets 230, 231 have slits 239s.

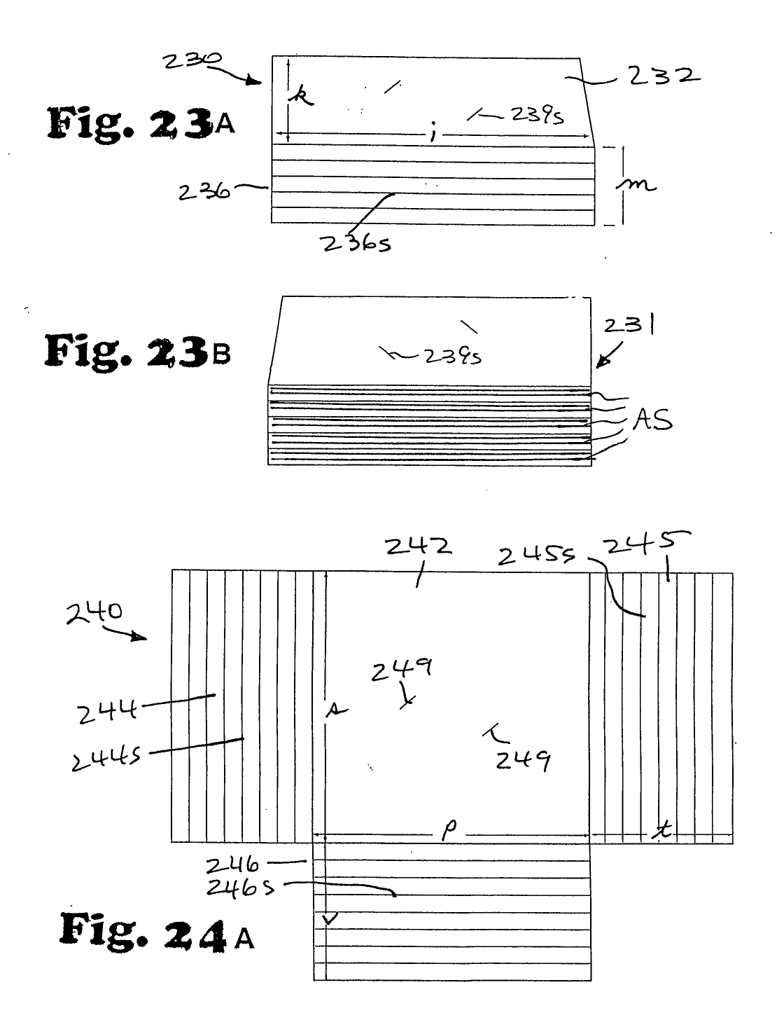

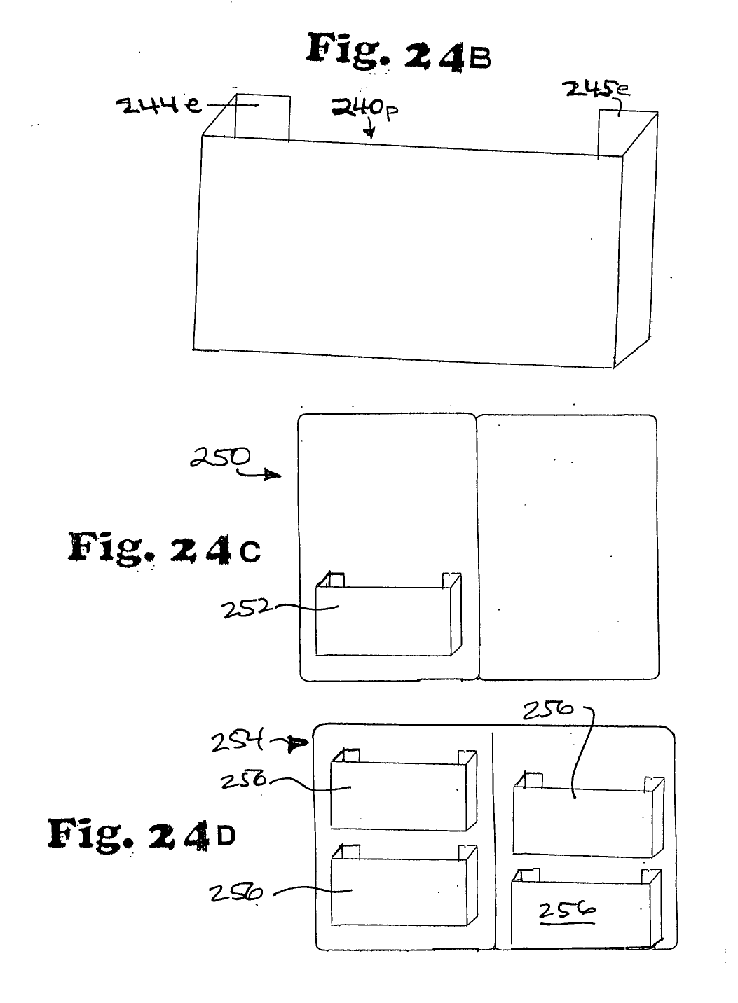

FIG. 24A shows a pocket 240 according to the present invention which has a main body 242, a side portion 244, a side portion 245, and a bottom portion 246. Optionally there are slits 249. The side portion 244 has lines 244s (optionally printed, scored and/or perforated) for folding the side portion 244. Optionally the side portion 245 has lines 245s (optionally printed, scored and/or perforated) for folding the side portion 245. Optionally the bottom portion 246 has lines 246s (optionally printed, scored and/or perforated) for folding the side portion 246.

In one aspect, a length “p” is 6 inches; a length “s” is 6 inches; and a length “t” is 5.75 inches.

In one aspect, the side portions 244, 245 and/or bottom portion 246 are folded in accordion-like fashion (e.g. see FIG. 22D) so that an expandable pocket is provided. In another aspect, as shown in FIG. 24B, the pocket 240 is formed as a pocket 240p and ends 244e and 245e of the side portions are connected to a thing (e.g. a folder's interior or exterior) and a portion of the bottom 246 (not shown) is also connected to the thing.

FIG. 24C shows a folder 250 with a pocket 252 (like the pocket 240 or the pocket 240p) connected thereto. FIG. 24D shows a folder 254 with pockets 256 (like the pocket 240 or the pocket 240p) connected thereto. Side portions of the pockets 252, 256 are adhesively connected to their respective folders. Optionally, the side portions and bottom portions of the pockets 252, 256 are folded in accordion-like fashion so that an expandable pocket is provided.

In any of the pockets of FIGS. 22A-24B, a plurality (two, three, etc.) of adhesive strips AS (see, e.g. FIG. 23B) can be provided on any side portion and/or on any bottom portion, with or without a removable cover, to provide multiple adherence lines for a pocket or a selection of adherence lines when one is to be used.

Any pocket according to the present invention (e.g. as in FIGS. 1, 7, 12-24A) may be connected to any part of a folder (exterior or interior), e.g., but not limited to, as any pocket connection disclosed herein. Any folder according to the present invention may have any pocket according to the present invention, pockets according to the present invention, or different pockets according to the present invention.

The present invention, therefore, provides in some, but not in necessarily all embodiments a method for making a folder, the folder having a side edge and a bottom edge, the method including: positioning a pocket adjacent a folder, the pocket having a main body, a side portion, and a bottom portion; folding the side portion of the pocket; folding the bottom portion of the pocket; connecting the side portion of the pocket to the folder; and connecting the bottom portion of the pocket to the folder. Such a method may one or some, in any possible combination, of the following: wherein the folder has an exterior and an interior and the side portion is folded over the side edge of the folder and is connected to the exterior of the folder and the bottom portion is folded over the bottom edge of the folder and is connected to the exterior of the folder; wherein the folder has an exterior and an interior and the side portion is folded under itself and connected to the interior of the folder and the bottom portion is folded over the bottom edge of the folder and is connected to the exterior of the folder; wherein the folder has an exterior and an interior and the side portion is folded over the side edge of the folder and is connected to the exterior of the folder and the bottom portion is folded under itself and is connected to the interior of the folder; wherein the side portion and the bottom portion are connected to the folder with adhesive, staple(s), and/or releasably cooperating fastener material, e.g., but not limited to, VELCRO (Trademark) material; wherein the side portion is connected to the folder with an adhesive strip and the bottom portion is connected to the folder with an adhesive strip, each adhesive strip initially covered with a removable cover which is removed for connection to the folder; wherein the side portion is elongated and a part thereof is removed prior to connection to the side portion to the folder so that a pocket of desired width is formed; wherein the bottom portion is elongated and a part thereof is removed prior to connection to the bottom portion to the folder so that a pocket of desired length is formed; wherein the side portion is elongated and a part thereof is removed prior to connection to the side portion to the folder so that a pocket of desired width is formed, and the bottom portion is elongated and a part thereof is removed prior to connection to the side portion to the folder so that a pocket of desired length is formed; wherein the side portion is folded in accordion-like fashion to provide an expandable pocket and/or wherein the bottom portion is folded in accordion-like fashion to provide an expandable pocket; forming at least one slit in the pocket to hold an item; wherein the at least one slit is two spaced-apart slits; wherein the item is a business card and releasably holdable in the slits; and/or in which the main body of the pocket with the pocket connected to the folder is adjacent the interior of the folder and the main body is one thickness of material not folded on itself.

The present invention, therefore, provides in some, but not in necessarily all embodiments a method for making a folder, the folder having a side edge and a bottom edge, the method including positioning a pocket adjacent a folder, the pocket having a main body, at least one side tab, and at least one bottom tab, folding the at least one side tab of the pocket, folding the at least one bottom tab of the pocket, connecting the at least one side tab of the pocket to the folder, and connecting the at least one bottom tab of the pocket to the folder.

The present invention, therefore, provides in some, but not in necessarily all embodiments a method for making a folder, the folder having a side edge and a bottom edge, the method including: positioning pockets adjacent a folder, each pocket having a main body, a side portion, and a bottom portion; folding the side portions of the pockets; folding the bottom portions of the pockets; connecting the side portions of the pockets to the folder; and connecting the bottom portions of the pockets to the folder.

The present invention, therefore, provides in some, but not in necessarily all embodiments a method for making a folder, the method including positioning a pocket structure adjacent a folder, the folder having an interior side and an exterior side, the pocket structure having a main body sheet, a side portion, and a bottom portion, the method including folding the side portion under itself and connecting the side portion to the interior of the folder, and folding the bottom portion under itself and connecting the bottom portion to the interior of the folder.

The present invention, therefore, provides in some, but not in necessarily all embodiments a pocket for connection to a folder, the pocket comprising any pocket according to the present invention disclosed herein.

The present invention, therefore, provides in some, but not in necessarily all embodiments a folder including: body; at least one pocket connected to the body, the at least one pocket comprising any pocket according to the present invention disclosed herein; such a folder wherein the at least one pocket is a plurality of pockets; and/or such a folder wherein the pockets are not the same.

The present invention, therefore, provides in some, but not in necessarily all embodiments a method for making a folder, the folder having a side edge and a bottom edge, the method including: positioning a pocket adjacent a folder, the pocket having a main body, two side portions, and a bottom portion; folding parts of each side portion of the pocket and part of the bottom portion of the pocket in accordion-like fashion; connecting the side portions of the pocket to the folder; and connecting the bottom portion of the pocket to the folder.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. The inventors may rely on the Doctrine of Equivalents to determine and assess the scope of their invention and of the claims that follow as they may pertain to apparatus and/or methods not materially departing from, but outside of, the literal scope of the invention as set forth in the following claims. All patents and applications identified herein are incorporated fully herein for all purposes.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

What is claimed is:

1. A method for making a folder, the folder having a side edge and a bottom edge, the method comprising
positioning a pocket adjacent a folder, the pocket having a main body, a side portion, and a bottom portion,
folding the side portion of the pocket,
folding the bottom portion of the pocket,
connecting the side portion of the pocket to the folder, and
connecting the bottom portion of the pocket to the folder.

2. The method of claim 1 wherein the folder has an exterior and an interior and the side portion is folded over the side edge of the folder and is connected to the exterior of the folder and the bottom portion is folded over the bottom edge of the folder and is connected to the exterior of the folder.

3. The method of claim 1 wherein the folder has an exterior and an interior and the side portion is folded under itself and connected to the interior of the folder and the bottom portion is folded over the bottom edge of the folder and is connected to the exterior of the folder.

4. The method of claim 1 wherein the folder has an exterior and an interior and the side portion is folded over the side edge of the folder and is connected to the exterior of the folder and the bottom portion is folded under itself and is connected to the interior of the folder.

5. The method of claim 1 wherein the side portion and the bottom portion are connected to the folder with adhesive.

6. The method of claim 1 wherein the side portion is connected to the folder with an adhesive strip and the bottom portion is connected to the folder with an adhesive strip, each adhesive strip initially covered with a removable cover which is removed for connection to the folder.

7. The method of claim 1 wherein the pocket is connected to the folder with staples.

8. The method of claim 1 wherein
the side portion is elongated and a part thereof is removed prior to connection to the side portion to the folder so that a pocket of desired width is formed.

9. The method of claim 1 wherein
the bottom portion is elongated and a part thereof is removed prior to connection to the bottom portion to the folder so that a pocket of desired length is formed.

10. The method of claim 1 wherein
the side portion is elongated and a part thereof is removed prior to connection to the side portion to the folder so that a pocket of desired width is formed, and
the bottom portion is elongated and a part thereof is removed prior to connection to the side portion to the folder so that a pocket of desired length is formed.

11. The method of claim 1 wherein the side portion is folded in accordion-like fashion to provide an expandable pocket.

12. The method of claim 1 wherein the bottom portion is folded in accordion-like fashion to provide an expandable pocket.

13. The method of claim 1 wherein
the side portion is folded in accordion-like fashion, and
the bottom portion is folded in accordion-like fashion, to provide an expandable pocket.

14. The pocket of either claim 1 in which the main body of the pocket with the pocket connected to the folder is adjacent the interior of the folder and the main body is one thickness of material not folded on itself.

15. A method for making a folder, the folder having a side edge and a bottom edge, the method comprising
positioning a pocket adjacent a folder, the pocket having a main body, at least one side tab, and at least one bottom tab,
folding the at least one side tab of the pocket,
folding the at least one bottom tab of the pocket,
connecting the at least one side tab of the pocket to the folder, and
connecting the at least one bottom tab of the pocket to the folder.

16. The method of claim 15 further comprising
forming at least one slit in the pocket to hold an item.

17. The method of claim 16 wherein the at least one slit is two spaced-apart slits.

18. The method of claim 17 wherein the item is a business card and releasably holdable in the slits.

19. A pocket for connection to a folder, the pocket comprising
a main body,
two side portions,
a bottom portion,
parts of each side portion of the pocket and part of the bottom portion of the pocket foldable in accordion-like fashion,
the side portions of the pocket connectible to the folder, and
the bottom portion of the pocket connectible to the folder.

20. The pocket of claim 19 further comprising a folder, parts of each side portion of the pocket and part of the bottom portion of the pocket folded in accordion-like fashion, the side portions of the pocket connected to the folder, and the bottom portion of the pocket connected to the folder.
